(19) United States
(12) Patent Application Publication
(10) Pub. No.: US 2020/0269912 A1
(43) Pub. Date: Aug. 27, 2020

(54) STEER-BY-WIRE STEERING SYSTEM WITH ADAPTIVE RACK-AND-PINION POSITION ADJUSTMENT

(71) Applicants: THYSSENKRUPP PRESTA AG, Eschen (LI); THYSSENKRUPP AG, Essen (DE)

(72) Inventors: Leonard LAPIS, Sennwald (CH); Manuel ü ROHRMOSER, Thüringen (AT)

(73) Assignees: thyssenkrupp Presta AG, Eschen (LI); thyssenkrupp AG, Essen (DE)

(21) Appl. No.: 16/629,622

(22) PCT Filed: Jul. 9, 2018
(86) PCT No.: PCT/EP2018/068560

§ 371 Date: Jan. 9, 2020

(30) Foreign Application Priority Data
Jul. 14, 2017 (DE) 10 2017 115 850.2

(51) Int. Cl. B62D 6/00; B62D 3/12; B62D 5/00

(52) U.S. Cl. CPC B62D 6/002; B62D 5/006; B62D 3/12

(57) ABSTRACT

A method and system for rack-and-pinion position adjustment for a steer-by-wire steering system for a motor vehicle. A module provides adjustment of the rack-and-pinion position, by determining a position error from a difference between desired and estimated value(s) of the rack-and-pinion position and the rack-and-pinion speed in a feedback structure, from which a control variable is determined for controlling the rack-and-pinion and a disturbance variable compensation for the control variable is carried out in a feedforward structure by means of a rack force estimation.

The present invention relates to a method for rack-and-pinion position adjustment for a steer-by-wire steering system of a motor vehicle with the features of the preamble of claim 1, and a method for controlling a steer-by-wire steering system with the features of the preamble of claim 9, and a steer-by-wire steering system with the features of the preamble of claim 10.

In steer-by-wire steering systems, the position of the steered wheels is not directly coupled to the steering input means, for example, a steering wheel. A connection is established between the steering wheel and the steered wheels via electrical signals. The driver's steering request is picked up by a steering wheel sensor and the position of the steered wheels is adjusted via a steering regulator depending on the driver's steering request. A mechanical connection to the wheels is not provided, so that no direct force feedback is transmitted to the driver after actuation of the steering wheel.

Because the mechanical connection is omitted between the wheels and the steering wheel, a position adjustment of the rack-and-pinion and thus of the wheels is necessary. It is desirable to keep the position adjustment of the rack-and-pinion as exact as possible and free from interference.

A regulator for an electromechanical steering system, in which a frequency-dependent interference compensation is carried out, is known from publication DE 10 2014 105 088 A1. The regulator is designed to regulate an engagement of the server motor while taking into account interferences acting on the steering system.

EP 3 006 306 A1 discloses a method for an electromechanical steering system with a rack-and-pinion force estimation unit, which estimates the rack-and-pinion force based on the steering angle, the steering wheel speed, and other variables.

It is the object of the present invention to specify a method and a device for rack-and-pinion position adjustment in a steer-by-wire steering system, which reliably and accurately adjust the rack-and-pinion position.

This problem is solved by a method for rack-and-pinion position adjustment in a steer-by-wire steering system of a motor vehicle with the features of claim 1, a method for controlling a steer-by-wire steering system for motor vehicles with the features of claim 9, and a steer-by-wire steering system for motor vehicles with the features of claim 10. Advantageous refinements of the invention are listed in the subclaims.

Accordingly, a method is provided for rack-and-pinion position adjustment for a steer-by-wire steering system for a motor vehicle which comprises a module for adjusting a rack-and-pinion position, which module determines a position error from the differences between the desired and estimated values of the rack-and-pinion position and the rack-and-pinion speed in a feedback structure, from which a control variable is determined for controlling a rack-and-pinion, wherein an disturbance variable compensation for the control variable of a steering mechanism is carried out in a feedforward structure by means of a rack-and-pinion force estimation. This method enables an adaptive, agile, and high-precision rack-and-pinion position adjustment based on a simple, physical steering mechanism model. In the feedforward structure, an estimated disturbance variable, for example, an estimated disturbance in the tire return force, is added to the control variable for adjusting the rack-and-pinion.

It is advantageous if, in another feedforward structure, a friction force compensation of the control variable is carried out by means of an estimation of the coefficient of static friction and a friction model. By this means, the adjustment is more accurate.

Correspondingly, the estimated friction force is added to the control variable of the rack-and-pinion in the feedforward structure.

The friction force compensation and/or the disturbance variable compensation is/are preferably carried out by means of a non-linear adaptive estimator, in particular, a Kalman filter. It is also preferred if the feedback structure comprises a linear quadratic regulator, such that the two do not impair each other and the regulator may correspondingly set the rack-and-pinion position, and/or non-linearities are considered in the feedforward structure and linear systems are considered in the feedback structure.

It is advantageous if the estimated coefficient of static friction is included as input in the rack-and-pinion force estimator.

The coefficient of static friction is preferably supplied to the friction model as input, together with the rack-and-pinion speed estimated by the rack-and-pinion force estimator.

In one preferred embodiment, the friction model compensates for the friction force, and the torque resulting therefrom is added to the estimated rack-and-pinion force and to the control variable for controlling the rack-and-pinion. The estimated rack-and-pinion force is previously converted into an estimated rack-and-pinion torque by means of a conversion factor mechanically determined at the engine level.

The friction model is preferably an asymmetrical, modified dynamic friction model, in particular a Lund-Grenoble friction model.

In addition, a method is for controlling a steer-by-wire steering system for a motor vehicle is provided, comprising:
an electronically adjustable steering adjuster acting on steered wheels,
a control unit,
a feedback actuator, which may be actuated via a steering input means by a driver with a driver's request for a steering angle, and emits a feedback signal to the steering input means as a reaction to the driver's request and a vehicle state of the motor vehicle,
a signal transmission, which transmits the driver's request to the control unit,
wherein the control unit controls the steering adjuster in order to transform the driver's request into a deflection of the steered wheels, wherein the control unit comprises a module for adjusting the rack-and-pinion position which adjusts the rack-and-pinion position by means of the previously described method.

In addition, a corresponding steer-by-wire steering system for a motor vehicle is provided, which is designed to carry out the previously described method.

Preferred embodiments of the invention are subsequently explained in greater detail with reference to the drawings. Identical or identically-functioning components are designated with the same reference numerals in the figures. Shown are:

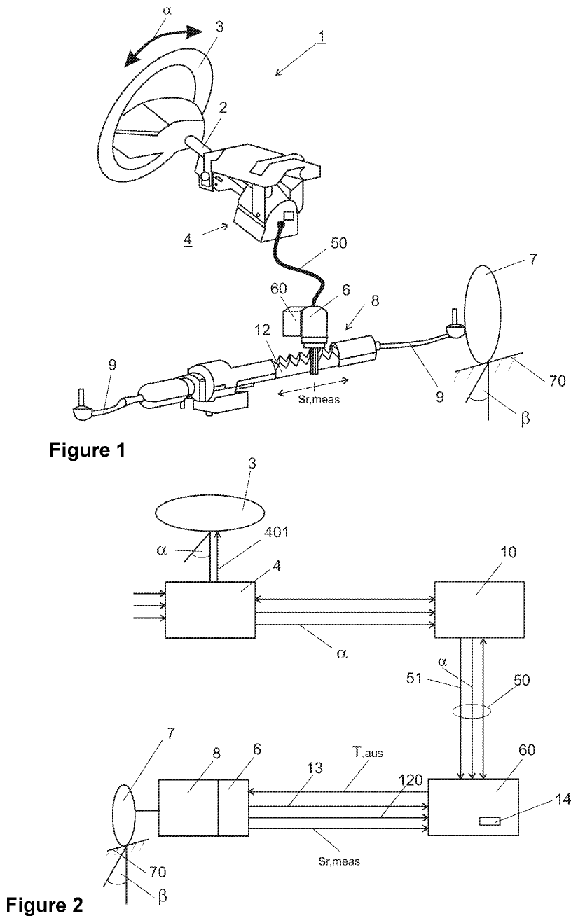

FIG. 1: a schematic representation of a steer-by-wire steering system,

FIG. 2: a block diagram of a control of the steer-by-wire steering system with a module for adjusting the rack-and-pinion position,

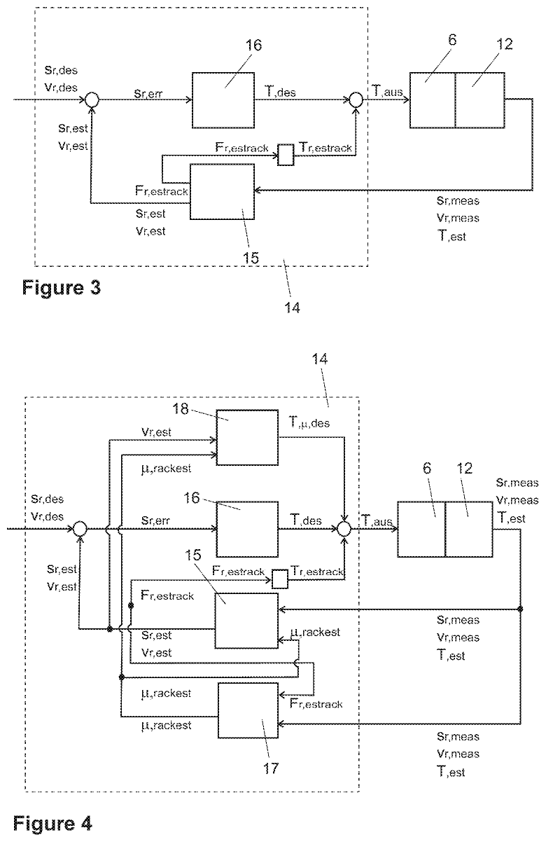

FIG. 3: a block diagram for adjusting the rack-and-pinion position, and

FIG. 4: a block diagram of another adjustment of the rack-and-pinion position with a rack and-pinion friction model and a rack and-pinion friction estimation unit.

A steer-by-wire steering system 1 is shown in FIG. 1. A rotation angle sensor (not shown), is applied on a steering shaft 2 and detects the driver steering angle α, which is applied by turning a steering input means 3, designed as a steering wheel in the example, which angle may be designated as a steering wheel rotation angle or a driver's steering request. However, a steering torque may also be detected. A joystick may function as the steering input means. Furthermore, a feedback actuator 4 is applied to steering shaft 2 and functions to simulate the feedback from roadway 70 on steering wheel 3, for example, using a reset torque 401 or a resistance torque which acts on steering wheel 3, and by this means gives feedback to the driver about the steering and driving behavior of the vehicle. The driver's steering request is transmitted, using the steering wheel angle of rotation α of steering wheel 2, measured via the rotational angle sensor, via signal lines to a feedback actuator monitoring unit 10, as is illustrated in FIG. 2. The steering wheel angle of rotation α may thereby comprise several rotations, for example, in a range from −720° to +720°, whereby 0° represents the desire to drive straight ahead. The feedback actuator monitoring unit 10 transmits the driver's steering request, via the applied steering wheel angle of rotation α, to a control unit 60. The feedback actuator monitoring unit 10 preferably also assumes the control of the feedback actuator 4. The feedback actuator monitoring unit 10 may also be designed as integral with control unit 60. The control unit 60 controls an electric steering adjuster 6, which controls the position of steered vehicle wheels 7, depending on the signal from the rotational angle sensor and other input variables with a control variable T_{,aus}. The steering adjuster 6 acts indirectly via a steering rod-steering mechanism 8, for example, a rack-and-pinion steering mechanism, and via tie rods 9 and other components, on the steered vehicle wheels 7 and pivots the same to a steering wheel angle β.

FIG. 2 shows a control of the steer-by-wire steering system. The feedback actuator 4 receives signals, among others those from the rotational angle sensor, which measures and stores the steering wheel angle of rotation α, the steering wheel acceleration, and the steering wheel speed at the steering wheel 3. The feedback actuator 4 communicates with a feedback actuator monitoring unit 10, which controls the feedback actuator 4. The feedback actuator monitoring unit 10 additionally receives roadway information 13 from a control unit 60 of the steering adjuster 6 via signal lines 50, for example the roadway state or a vehicle steering angle. The control unit 60 receives driver-side steering commands 51, like the steering wheel angle of rotation α, from the feedback actuator monitoring unit 10 via the signal line 50.

The control unit 60 determines, in a module 14 for adjusting the rack-and-pinion position depending on the driver's steering request and other signals, which the feedback actuator monitoring unit 10 transmits, a desired rack-and-pinion position s_{r,des} and a desired rack-and-pinion speed v_{r,des} of a rack-and-pinion 12, such that the desired torque or control variable T_{,des} may be determined therefrom for the electric steering adjuster 6. Alternatively to the rack-and-pinion position, the wheel steering angle β of steered wheels 7 may be used to determine the control variable. The wheel steering angle β for pivoting the steered vehicle wheels 7 is specified from the control variable T_{,des}, as well as other variables which the control unit 60 has determined.

Measured values 120 from the steering adjuster 6 and the steering mechanism 8, for example the force measured on the rack-and-pinion 12, the wheel steering angle, and roadway information 13, as well as rack-and-pinion position s_{r,meas}, are forwarded to the control unit 60.

Two embodiments are shown in FIGS. 3 and 4 of the module 14 for adjusting the rack-and-pinion position.

As is depicted in FIG. 3, the module 14 receives desired rack-and-pinion values as input for adjusting the rack-and-pinion position s_{r,est}. These include the desired rack-and-pinion position s_{r,des} and the desired rack-and-pinion speed v_{r,des}. A rack-and-pinion force estimation unit 15 also estimates the rack-and-pinion position s_{r,est} and the rack-and-pinion speed v_{r,est}, in addition to the rack-and-pinion force F_{r,est}. A position error s_{r,err} is determined from the difference between the desired values and the estimated values of the rack-and-pinion position and the rack-and-pinion speed, from which a regulator 16 initially specifies a control variable T_{,des}, which corresponds to a desired torque for controlling rack-and-pinion 12. The estimated rack-and-pinion force F_{r,estrack} (=control variable, non-linear part of the desired torque) is converted by means of a mechanically determined conversion factor at the engine torque level, such that an estimated rack-and-pinion torque T_{r,estrack} is specified therefrom and added to the initially specified control variable T_{,des}, and by this means the actual control variable T_{,aus} to be output is specified, which is then forwarded to the steering adjuster 6 for controlling the rack-and-pinion 12. The current rack-and-pinion position s_{r,meas} and the rack-and-pinion speed v_{r,meas} are measured at the rack-and-pinion 12 and an estimated desired torque T_{,est} is determined at the rack-and-pinion 12. These values s_{r,meas}, v_{r,meas} and T_{,est} are supplied as input to the rack-and-pinion force estimation unit 15.

The rack-and-pinion force estimation unit 15 functions using non-linear estimation methods (EKF) while the regulator 16 (Linear Quadratic Regulator (LQR)) functions using linear methods, so that the two do not impair each other and the regulator 16 may correspondingly adjust the rack-and-pinion position.

FIG. 4 shows a module for regulating the rack-and-pinion position s_{r,est}, corresponding to FIG. 3, which, however, has been expanded by a rack-and-pinion friction estimation unit 17 and a rack-and-pinion friction model 18 for improved accuracy.

The estimator of the rack-and-pinion friction estimation unit 17 is, like the rack-and-pinion force estimator of rack-and-pinion force estimation unit 15, a non-linear adaptive estimator and receives the measured rack-and-pinion position s_{r,meas}, measured rack-and-pinion speed v_{r,meas}, estimated desired torque T_{,est} and estimated rack-and-pinion force F_{r,estrack} as inputs, and forms from them a coefficient of static friction μ_{,rackest} (Stribeck friction). The coefficient of static friction is supplied to the friction model 18 as input together with the rack-and-pinion speed v_{r,est} estimated by the rack-and-pinion force estimator 15. The friction model compensates for friction force and specifies from this a torque T_{μ,des}, which is converted from the estimated rack-and-pinion force F_{r,estrack} (=control variable, non-linear part of the desired torque) by means of the mechanically determined conversion factor at the engine torque level into the estimated rack-and-pinion torque T_{r,estrack}, and is added to the initially determined control variable T_{,des}, which is how the actual control variable T_{,aus} to be output is determined, which is then supplied to the steering adjuster. By this means, the non-linear characteristics and the unknown disturbance variables of the system are compensated. The remaining linear dynamics of the system are effectively adjusted using the linear quadratic regulator 16 (LQR). The LQR is based on a linear rack-and-pinion model, in which the mass, damping, and stiffness of the rack-and-pinion are included, and which preferably comprises the position error, speed error, and position integral error of the rack-and-pinion.

The rack-and-pinion friction model is composed of a static model comprising static and kinetic friction or a dynamic friction model (for example, Lund-Grenoble model).

The coefficient of static friction μ_{,rackest} is also included as additional input into the rack-and-pinion force estimator 15, along with s_{r,meas}, v_{r,meas} and T_{,est}.

The rack-and-pinion position, rack-and-pinion speed, the control variable, and the friction force are continuously estimated in the respective estimation unit using a Kalman filter. The concept of a Kalman filter relates to a method for estimating the temporal development of non-linear systems, by means of which interferences may be removed from a measurement signal. For this purpose, the filter requires a model of the system to be estimated.

1.-10. (canceled)

11. A method for the adjustment of a rack-and-pinion position for a steer-by-wire steering system for a motor vehicle, comprising:
providing a module configured to adjust a position of a rack-and-pinion,
determining, with the module, a position error from a difference between a desired and an estimated value of the rack-and-pinion position and a rack-and-pinion speed in a feedback structure,
determining, from the position error, a control variable to control the rack-and-pinion, and
carrying out a disturbance variable compensation for the control variable via a feedforward structure via a rack-and-pinion force estimation.

12. The method of claim 11, further comprising carrying out a friction force compensation of the control variable in another feedforward structure via an estimation of a coefficient of static friction and a friction model.

13. The method of claim 12 wherein the friction force compensation and/or the disturbance variable compensation is carried out via a non-linear adaptive estimator.

14. The method of claim 11 wherein the feedback structure comprises a linear quadratic regulator.

15. The method of claim 12 wherein the estimated coefficient of static friction is included as input in a rack-and-pinion force estimator.

16. The method of claim 15 wherein the estimated coefficient of static friction is supplied to the friction model as an input, together with the rack-and-pinion speed estimated by the rack-and-pinion force estimator.

17. The method of claim 12 wherein the friction model compensates for the friction force and determines a torque therefrom, which is added to the estimated rack-and-pinion force and to the control variable for controlling the rack-and-pinion.

18. The method of claim 12 wherein the friction model is an asymmetrical, modified, dynamic friction model.

19. A method for controlling a steer-by-wire steering system for a motor vehicle, the system comprising an electronically adjustable steering adjuster acting on steered wheels, a control unit, a feedback actuator, configured to be actuated via a steering input means with a driver's request for a steering angle, and emitting a feedback signal to the steering input means as a reaction to the driver's request and a vehicle state of the motor vehicle, the method comprising:
transmitting, via a signal transmission, the driver's request to the control unit, and
controlling, via the control unit, the steering adjuster to transform the driver's request into a deflection of the steered wheels,
wherein the control unit comprises a module configured to adjust the rack-and-pinion position via the method comprising:
determining, with the module, a position error from a difference between a desired and an estimated value of the rack-and-pinion position and a rack-and-pinion speed in a feedback structure,
determining, from the position error, a control variable to control the rack-and-pinion, and
carrying out a disturbance variable compensation for the control variable via a feedforward structure via a rack-and-pinion force estimation.

20. A steer-by-wire steering system for a motor vehicle, comprising:
an electronically adjustable steering adjuster acting on steered wheels of the motor vehicle,
a control unit,
a feedback actuator, which is configured to be actuated via a steering input means by a driver's request for a steering angle, and emit a feedback signal to the steering input means as a reaction to the driver's request and a vehicle state of the motor vehicle,
a device for signal transmission, which is configured to transmit the driver's request to the control unit,
wherein the control unit controls the steering adjuster to transform the driver's request into a deflection of the steered wheels,
wherein the steer-by-wire steering system is configured to carry out a method comprising:
determining, with the module, a position error from a difference between a desired and an estimated value of the rack-and-pinion position and a rack-and-pinion speed in a feedback structure,
determining, from the position error, a control variable to control the rack-and-pinion, and
carrying out a disturbance variable compensation for the control variable via a feedforward structure via a rack-and-pinion force estimation.
